(19) United States
(12) Patent Application Publication
(10) Pub. No.: US 2009/0304451 A1
(43) Pub. Date: Dec. 10, 2009

(54) LOAD BEARING SYSTEM

(75) Inventors: PAUL ANTONIUS ALPHONSUS GEENE, Leiden (NL); EUGENE ALEXANDER BAJEMA, Katwijk a/d Rijn (NL)

Correspondence Address: HOFFMANN & BARON, LLP, 6900 JERICHO TURNPIKE, SYOSSET, NY, 11791, US

(73) Assignee: HEEREMA MARINE CONTRACTORS NEDERLAND B.V., Leiden (NL)

(21) Appl. No.: 12/478,821

(22) Filed: Jun. 5, 2009

Related U.S. Application Data
(60) Provisional application No. 61/059,509, filed on Jun. 6, 2008.

(51) Int. Cl. F16L 1/00; F16L 3/00; B63B 35/03; F16L 55/00; F16L 9/22

(52) U.S. Cl. 405/154.1; 405/184.4; 405/166; 285/18; 138/106; 138/155

(57) ABSTRACT

The present invention relates to a tubular member configured to be supported by a pipe support device on board a pipelay vessel, the tubular member comprising at least one load bearing surface which is formed along the outer side of the tubular member, the at least one load bearing surface being constructed and arranged in order to allow a substantial axial load to be imparted onto said tubular member by the pipe support device, wherein the at least one load bearing surface tapers outwardly with respect to a main longitudinal axis of said tubular member. The present invention also relates to a tubular member comprising a plurality of load bearing surfaces. The present invention also relates to a method of laying a pipeline, to a pipe support device, to a pipelay vessel, to a method of processing a tubular member, to a method of assembling a pipe assembly and to a pipe assembly.

### CROSS-REFERENCE TO RELATED APPLICATIONS:

This application claims the benefit of U.S. Provisional Application No. 61/059,509, filed Jun. 6, 2008, the contents of which is incorporated by reference herein.

### FIELD OF THE INVENTION

There is an increasing need for underwater pipelines for the transport of hydrocarbons. Fields are being developed that are located in increasingly deep water. Also, relatively small fields are being developed. Because smaller and deeper fields are being developed, it is often not cost effective to install a floating production facility above each field. Therefore, a tendency in the field of the art exists to connect a well location to a floating production facility located at an increasing distance from the well location and to connect the production facility to a number of other fields. This leads to longer flowlines between a well location and a production facility.

To prevent the pipeline from being obstructed by the deposits of hydrates or wax, the product that flows through the pipeline should often reach the production facility without cooling off too much. Also, in the event of an interruption in the production which causes the fluids from the well to stop flowing, the temperature of the product in the pipeline should not drop very quickly, but should be substantially maintained over a certain time period.

Because of the tendency for longer flowlines, the product generally takes a longer time to travel from the well to the production facility. Because of this longer time period, the maintenance of a sufficient temperature is increasingly important. Therefore, thermal insulation requirements of pipelines become more important. In order to fulfill the requirements related to the flow assurance, a well insulated pipeline is required.

In order to obtain the required thermal performance, a single walled pipeline with insulation coating on the outside (so called wet coating) does not always suffice. There are not many external insulation coatings that can withstand the water pressure at several kilometers of water depth and also provide the required insulation values.

Therefore, in these circumstances it is often preferred to install a double walled pipeline, also known as a pipe-in-pipe line. Pipe-in-pipe lines can reach insulation values superior to wet coating. The space between the outer pipe and the inner pipe, the so called annulus, can be left empty, but for additional thermal insulation capacity the annulus may be filled with insulation material. This can be relatively cheap material since it does not have to resist the pressure of the sea water.

Pipe-in-pipe systems comprise two pipelines, one pipeline inside the other pipeline. Because more of material is used to construct the pipeline than for single wall pipelines, a pipe-in pipe system tends to be expensive.

If the annulus between the inner and outer pipe is small, a smaller outer pipe may be used for a same inner pipe. This results in a reduction of used material and thus in a cost reduction. Thus, one way to optimize the cost of such a system is to make the annulus as small as possible.

### PRIOR ART

Reference is made to patent application US2006156530. This application discloses a method to manufacture a double walled pipe system according to the sliding pipe-in-pipe system. A sliding pipe-in-pipe system comprises an inner pipe which is substantially loose from the outer pipe. The inner pipe is only connected to the outer pipe via bulkheads which are provided at a relatively large distance from one another, in the range of several kilometers between two bulkheads.

The referenced installation method includes pulling the inner pipe out of the outer pipe over a certain distance at the pipelay vessel prior to installation of such a bulkhead. A part of the inner pipe is cut off prior to the welding of the bulkhead to ensure that the inner pipe remains under tension after the bulkhead is welded in its final position. This may be required to prevent the inner pipe from buckling inside the outer pipe when it is repeatedly heated and cooled off.

In the final situation, the inner pipe is under tension stress, while the outer pipe is under compressive stress. The forces are transferred via the bulkheads.

In order for this method to work, the tensioned inner pipe has to be supported during cutting and welding of the bulkhead on the inner pipe. US2006156530 discloses a system wherein a tubular collar 106 is used for supporting the inner pipe. Reference is made to FIG. 7g of US2006156530 which is enclosed herein as FIG. 12. Collars are known from the art.

The method from US2006156530 has proven to work well in practice. The force required to pull the inner pipe out of the outer pipe may be considerable, i.e. up to several hundreds of tons. During the welding of the inner pipe to the bulkhead, this force has to be transferred from the inner pipe to a supporting structure via the collar 106 on the inner pipe.

The substantial force exerted on the collar 106 necessitates a substantial size of the bearing area of said collar. This size in turn may become the primary driver for the size of the annulus, which is a primary cost factor. Thus, the solution of US2006156530 may lead to an expensive system. This is an undesirable situation. A need for a more cost-effective method is present.

Collars are also often used during construction of single walled pipelines. Especially in the J-lay method where the pipeline is launched from the installation vessel from a vertical or inclined tower, collars may be used. Other methods are also used, wherein the weight of the pipe is carried by a system that works on friction, like tensioners or friction clamps.

One advantage of collars over a friction system is that it can be more accurately determined how much load can be carried by the pipeline support system on the vessel, since load is transferred via bearing surfaces. Friction based solutions use a friction factor to determine the load bearing capacity, which factor is subject to uncertainty. There are examples where pipelines have slipped from such a system and subsequently dropped to the seabed.

Another advantage of collars is that the support structure is in general significantly smaller for a collar system than for a friction system, especially when very high loads have to be transferred. The required contact area between friction equipment and the pipeline becomes very large, in the order of several meters.

Another advantage of collars is that no separate buckle arrestors have to be installed on the pipeline, which may be the case when friction based support systems are used.

A known drawback of a system with collars over a friction based system is that the load bearing elements are in general costly forgings.

Also, collars made from forgings have to be welded onto a pipe section prior to the connection of said pipe section to the suspended pipeline. The welding of a forging piece to an end of a pipe section requires a different welding procedure than the welding of two pipe sections in an end-to-end relationship. This is due to the fact that two different materials are involved, whereas in welding of pipe sections end-to-end, a single material is involved. Weld procedures are standardized and regulated. Thus, when forgings are used, at least two weld procedures must be executed during the pipeline production process. Since each separate weld procedure is very costly to get qualified for use, it is advantageous if the forgings can be dispensed, so that the number of weld procedures to get qualified is reduced.

The need for obviating the forgings applies for both pipe-in-pipe lines as for single wall pipelines. Therefore, there also is a need for a system of laying single wall pipelines which can be performed without using forgings.

### OBJECTS OF THE INVENTION

The present invention aims to overcome at least one of the problems mentioned above.

The present invention has a further objective of providing a system that enables the method of US2006156530 to be performed for relatively small annuluses of a pipe-in-pipe system.

It is a further object of the invention to provide a solution for a single wall pipe laying system which can be used without forgings.

It is a further object of the invention to provide a pipe-in-pipe laying system which can be used without forgings.

It is a further object of the invention to provide a simple and reliable variant to known collar systems.

### SUMMARY OF THE INVENTION

In order to achieve at least one of the above mentioned objectives, the invention provides a tubular member configured to be supported by a pipe support device on board a pipelay vessel, the tubular member comprising at least one load bearing surface which is formed along the outer side of the tubular member, the load bearing surface being configured such that a weight of a pipeline suspended from the vessel can be carried via the at least one load bearing surface, wherein the at least one load bearing surface tapers outwardly with respect to a main longitudinal axis of said tubular member.

The tapering of the load bearing surface advantageously allows a smaller maximum diameter of the tubular member in comparison with known collar systems. The angle between the pipe wall and the load bearing surface is less than 90 degrees. The pipe wall makes a gradual transition into the load bearing surface.

This transition can not be very abrupt, because an abrupt transition implies a more or less ‘sharp’ corner between the pipe wall and the load bearing surface. A sharp corner will result in peak stresses in the area of the corner. A smaller angle between the pipe wall and the load bearing surface enables a smaller transition area between the pipe wall and the load bearing surface and thus, a smaller outer diameter of the load bearing surface.

The load bearing surface may taper at different angles.

The pipe support device forms part of a pipelay system such as a J-lay system. The pipe support device may comprise a movable clamp and a fixed clamp or may comprise a movable hangoff table and a fixed hangoff table.

The present invention provides a solution to reduce stress concentration by placing the load bearing surface under an angle with respect to the axis of the tubular member. In this way the stresses are more gently (or gradually) transferred into the pipeline. However, the design according to the invention will lead to higher hoop stresses and horizontal forces which will push the hang off construction sideways. Calculations have shown that the total load bearing capacity can be optimized by placing the load bearing surface under an angle.

In a suitable embodiment, a least one load bearing surface extends at an angle of 50-70 degrees with respect to a main longitudinal axis of the tubular member. These angles have been found to allow high axial loads. Peak stresses are maintained within acceptable levels.

In a suitable embodiment, the tubular member comprises a plurality of load bearing surfaces of which at least one is tapered. Also, a plurality of tapered load bearing surfaces may be provided. The load bearing surfaces are provided at a distance from one another, wherein the load bearing surfaces are constructed such that in use the total axial load to be transferred from the pipe support device onto the tubular member is distributed over the respective load bearing surfaces.

It is also possible that a plurality of load bearing surfaces are provided, of which one or several are tapered and one or more load bearing surfaces are not tapered. The combined effect will be that the outer diameter of the plurality of load bearing surfaces is smaller than the systems known in the prior art.

The tubular member of the invention is suitable for use in a pipe-in-pipe system. A smaller annulus may be applied, leading to a decrease in cost.

The present invention is also advantageous for a single walled pipe because for a single wall pipeline, a reduction of the bearing area of a collar is also advantageous. If the width of the bearing part of the pipeline can be reduced, the cost of the forgings that these collars are made out of may be significantly reduced. Alternatively, it is possible to produce bearing parts out of thick walled pipe by machining the bearing elements out of the wall. This is beneficial for the overall pipeline cost since the tubular members may then be made from the same material as the pipeline itself, which is less expensive than forging material.

The above mentioned advantages also apply for a pipe-in-pipe system. Pipe-in-pipe lines also use expensive forgings. The present invention may also lead to a smaller and thus more cost-effective forging for pipe-in-pipe systems or to a complete avoidance of the use of forgings by using thick-walled pipe sections.

Preferably, said tubular member is manufactured from steel. In this way, costly forgings are not necessary.

In a suitable embodiment, the tubular members have a length of between 0.5 and 14 meter and intended to be joined to a longer pipe section which is to be laid in a J-lay method. This allows the tubular member to be combined with regular pipe sections into a pipe assembly.

In an exemplary embodiment, the tubular member comprises:
a coupling region at a coupling end of the tubular member, the coupling end being constructed to be connected to said pipe section, wherein said coupling region has a coupling inner diameter and a coupling outer diameter corresponding to the regular pipeline wall dimensions, and a
support section comprising the at least one load surface, said support section having a different outer diameter than the coupling section.

The tubular member will generally also have a coupling region at the opposite end, for coupling with a next pipe section.

Preferably, a transition of the difference in the outer diameter between the coupling section and the support section is bridged via a bridging section which comprises an at least partially curved section.

The difference in wall thickness between the bearing area of the tubular member of the invention and the regular pipeline wall thickness is bridged by reducing the wall thickness by machining one or more elliptical fillets in the steel. The outer diameter of the tubular member is advantageously kept as small as possible from a point of material use. Small elliptical fillets are advantageous from this point of view. On the other side, small elliptical fillets may in some situations lead to unacceptable stress concentrations.

The stress concentrations can be limited by increasing the height of the collar. This also means increased material use, since the minimum length of the tubular member will increase. Thus, an optimum for the size of the elliptical fillet is amongst others driven by the axial load to be transferred and the moment induced on the pipeline by the hang off means. For larger collars, fillets with a larger radius can be applied in the transition between collar and pipe. When smaller collars are used, elliptical fillets with sharper curves need to be applied in order to maintain a reasonable bearing area. The tighter curves are more sensitive to stress concentrations.

Preferably, the at least one load bearing surface forms at least partially a conical surface. A conical form is suitable to bear large forces.

In an alternative embodiment said at least one load bearing surface extends at an angle to the longitudinal axis of the pipeline between 2 and 10 degrees, preferably around 5 degrees. In this different embodiment, the hoop stresses are much larger than for 50-70 degrees. However, with a suitable wall thickness of the tubular member, peak stresses can be maintained at acceptable levels.

In another embodiment, a plurality of rims are formed on the outer wall of the tubular member, wherein a part of the surface of each rim forms said load bearing surface. Contrary to the known collars, the rims are small in comparison with the diameter of the tubular member. A plurality of rims is required in order to have a same load bearing capacity as a single wider collar. The maximum diameter of the rims can be much smaller than the maximum diameter of a single collar or a double collar.

In a suitable embodiment, the rims are welding beads deposited on the outer wall of the tubular member. This embodiment allows the use of regular pipe sections for the ‘handle’ function by simply depositing welding beads, for instance in the form of annular rings, on the outer wall of the tubular member. The welding beads are deposited according to a prescribed arrangement which corresponds to the form of the support device of the J-lay system.

Another embodiment comprises rims machined out of thick walled pipe made from the same material as the pipeline. Since the rims do not protrude much outside the nominal pipe diameter, only limited additional wall thickness is required for the thick walled pipe with respect to the regular pipe.

The invention also relates to a pipe support device constructed and arranged to be provided on board a pipelay vessel, the pipe support device configured for imparting an axial load on a tubular member according to the invention comprising a tapered load bearing surface, the pipe support device comprising at least one support surface which tapers outwardly at an angle to an axis which in use is coaxial with a longitudinal axis of the tubular member, the at least one support surface constructed to in use engage the load bearing surface of said tubular member directly or indirectly via a deformable intermediate member.

With the pipe support device, tubular members according to the invention can be formed into a pipeline in a simple and effective way. Both pipe-in-pipe lines and single wall pipelines can be laid.

A problem to be overcome is to assure that all bearing elements carry approximately the load that is anticipated. It is possible that when the collar and the bearing construction do not exactly fit, a small part of the load bearing surfaces will carry the majority of the load, and other arts will carry only a small amount or even nothing.

In order to address this issue, the pipe support device may comprise at least one deformable member which is positioned between the at least one support surface and the load bearing surface of the pipe for substantially limiting stress peaks in the material due to size tolerances of the at last one support surface or the at least one load bearing surface.

One embodiment is to apply deformation rings made of a material with a lower yield stress than the pipe or the hang off construction between these elements during load transfer. In case the fit and/or load distribution between the load bearing surfaces and the hang off construction is not optimal, the deformation rings in between will deform, without substantially affecting the pipe or the hang-off construction.

Depending on the material that these deformation rings are made from, from a point of safety it may be required to use the rings only once, and discard of them after the first use. This makes the solution feasible in the case that not many hang off operations have to be performed, for instance in the case of bulkhead installation for a sliding pipe-in-pipe system. If such a solution would be used for a single pipe installation, requiring hang off at every pipeline section, a lot of deformation rings would be required, causing a lot of debris and leading to cost increase.

Another solution is to manufacture the load bearing surfaces from a material with lower yield strength than the hang off means. In this case, any fabrication inaccuracies will lead to deformation of the pipe material. As long as the deformation is limited and does not extend out of the additional wall thickness at the location of the collar this is acceptable. This concept leads to the possibility to further optimize the collar concept into solutions that still transfer load by bearing, however do not require a lot of additional wall thickness.

Preferably, the tapering angle between the at least one support surface and the longitudinal axis is between 50 and 70 degrees. This angle has been found to provide good results in terms of maximum axial loads and limited peak stresses.

In a suitable embodiment, the pipe support device comprises a plurality of tapered support surfaces which are provided at a distance from one another, the support surfaces being constructed such that in use the total axial load to be transferred onto said tubular member is distributed over the support surfaces.

In another embodiment, the pipe support may additionally comprise one or more support surfaces which are not tapered but extend at right angles with respect to a pipeline axis.

Load distribution allows for higher loads to be transferred via load bearing surfaces having a limited diameter.

Preferably, the at least one support surface is at least partially a conical surface. This is a simple and reliable form.

In a suitable embodiment, the at least one support surface extends at an angle to the longitudinal axis of the pipeline between 2 and 10 degrees, preferably around 5 degrees.

This embodiment results in small widths of the load bearing surfaces of the tubular member. However, substantial hoop stresses are created which require an increased wall thickness in order to disperse the stresses and limit the peak stresses. The increased wall thickness takes away a part of the advantage that is reached with the limited width of the load bearing surfaces

In a suitable embodiment, the pipe support device comprises a plurality of notches, wherein a part of each notch forms said support surface, the notches being constructed and arranged to engage a plurality of rims formed on the outer wall of the tubular member, wherein a part of the surface of each rim forms said load bearing surface.

This pipe support device can be used in combination with a tubular member having a plurality of rims.

In a suitable embodiment, the pipe support device comprises a plurality of support surfaces, the support surfaces being constructed such that they can engage welding beads deposited on the outer wall of the tubular member. This embodiment allows the use of regular pipe sections for the tubular member, wherein the regular pipe sections are provided with welding beads.

In a suitable embodiment, the pipe support device is configured for laying a pipe-in-pipe assembly comprising an inner pipe and an outer pipe, wherein said inner pipe is connected to a hoist device, the hoist device being constructed to hoist the inner pipe upward relative to the outer pipe, after which the tensioned inner pipe can be hung off via the support surface of the pipe support device.

With this embodiment, pipe-in-pipe lines with a small annulus can be laid.

The present invention also relates to a method of laying a pipeline, the method comprising at least:
providing a pipeline laying vessel comprising a pipe support device according to the invention,
providing a tubular member according to the invention,
supporting the tubular member by the pipe support device.

In a suitable embodiment, the method comprises:
providing a pipeline laying vessel comprising the pipe support device of the invention,
said pipe support device comprising at least one fixed tapered support surface and at least one moveable tapered support surface,
suspending a pipeline at a free end by said at least one fixed support surface,
providing a tubular member according to the invention, the pipe section being supported by the movable tapered support surface,
joining said tubular member to said pipeline,
disengaging the pipeline from the at least one fixed tapered support surface and lowering the combination of the pipeline and the pipe section which is joined thereto by the at least one moveable tapered support surface.

This method allows the laying of a pipeline in J-lay without the use of forgings, or with the use of forgings requiring significantly less material than required to produce collars known from the art.

In a suitable embodiment of the method, said pipeline comprises an inner pipeline and an outer pipeline of a pipe-in-pipe line, wherein at least the inner pipeline comprises a tubular member according to the invention, and wherein the tapered support surface engages the load bearing surface of the inner pipeline, and wherein the inner pipeline is moved upwards relative to the outer pipeline.

The invention also relates to a pipeline laying vessel comprising the pipe support device of the invention. With the pipeline laying vessel, more cost-effective pipe-in-pipe lines can be laid and more cost -effective single wall pipelines can be laid.

The invention further relates to a method of assembling a pipe assembly, the method comprising at least:
providing a tubular member,
providing at least one tapered load bearing surface on said tubular member, the load bearing surface being arranged and constructed to allow a pipeline to which said tubular member is connected to be suspended from a pipeline laying vessel.

With the method, cost-effective pipe assemblies can be assembled which can be used for J-lay.

In a suitable embodiment, the tubular member is joined to at least one regular pipe section in an end-to-end relationship prior to the joining of the assembly of the tubular member and the at least one pipe section to a pipeline suspended from a pipelay vessel.

Pre-assembly of pipe assemblies outside the critical path results in cost-effective pipelay.

In a suitable embodiment, said tubular member has a substantially same inner diameter as the regular pipe section, and wherein said tubular member has a greater outer diameter than said regular pipe section, and wherein the at least one tapered support surface is formed by removing a part of the material of the tubular member.

This embodiment provides a simple way of manufacturing the ‘handle’ members.

In a suitable embodiment, said tubular member and said pipe section are manufactured from a same material, in particular steel. The use of steel enables simple weld procedures.

In an exemplary embodiment, the method comprises providing rims of strong material around the outer wall of said tubular member, the rims being constructed and arranged to function as a load bearing surface for bearing a load which is imparted by a support surface of a pipelay vessel on the pipe assembly in order to suspend a pipeline from said pipelay vessel.

A plurality of rims is a very simple way of providing the required surface.

In another embodiment, said rims are welding beads of weld material which are deposited onto the outer surface of said pipe, the welding beads forming the load bearing surfaces. The welding beads allow a simple way of providing the load bearing surface. The welding beads are to be deposited according to a predetermined arrangement, in order to match the support surfaces of the pipe support device.

In one embodiment, the rims are endless loops extending along said outer wall of said tubular member. Endless loops can be constructed in a continuous process.

In another embodiment the rims are provided by using pipe material with a wall thickness that is greater than the standard pipe material, and removing material from the excess wall thickness so that rims are formed.

The invention further relates to a pipe assembly comprising the tubular member according to the invention and one or more regular pipe sections, the tubular member and the one or more regular pipe sections being joined to one another in an end-to end relationship. With the pipe assembly, cost-effective pipelay is possible.

### Multiple Load Bearing Surfaces

The invention also relates to a tubular member configured to form part of a pipeline which is laid by a pipeline laying vessel, the tubular member comprising a plurality of load bearing surfaces which are formed along the outer side of the tubular member, the load bearing surfaces being constructed and arranged in order to allow a substantial axial load to be imparted onto said tubular member, such that a pipeline to which said tubular member is connected can be suspended from a pipeline laying vessel, wherein a plurality of load bearing surfaces are provided for engaging a movable support device on the pipelay vessel and a plurality of load bearing surfaces are provided for engaging a fixed support device on the pipelay vessel.

The use of multiple small bearing areas instead of one bearing area that transfers the load provides an advantage in that the surface area per load bearing area can be smaller.

In a suitable embodiment stress concentrations in the bearing area are limited. In a suitable embodiment, a system is provided that guarantees that the load exerted on each bearing area does not exceed a maximum load which can be exerted on said bearing area.

The design of a small collar which is a scaled down version of known collars may lead to the effect that at certain points of the construction, stresses will accumulate and so called stress concentration points will occur. These points with stress peaks may limit the total load which the bearing element is able to transfer.

In another embodiment, the tubular member comprises a plurality of rims formed on the outer wall of the tubular member, wherein a part of the surface of each rim forms said load bearing surface. A plurality of relatively small rims provides an easy and effective way of supporting the tubular member.

The invention also relates to a pipe support device constructed and arranged to be provided on board a pipelay vessel, the pipe support device configured for imparting an axial load on a tubular member, with the tubular member comprising a plurality of load bearing surfaces which are formed along the outer side of the tubular member, the load bearing surfaces being constructed and arranged in order to allow a substantial axial load to be imparted onto said tubular member, such that a pipeline to which said tubular member is connected can be suspended from a pipeline laying vessel, wherein a plurality of load bearing surfaces are provided for engaging a movable support device on the pipelay vessel and a plurality of load bearing surfaces are provided for engaging a fixed support device on the pipelay vessel, wherein the pipe support device comprises a plurality of fixed support surfaces and a plurality of moveable support surfaces, wherein the fixed and moveable support surfaces are configured to cooperate in laying the pipeline.

The present invention further relates to a method of laying a pipeline, the method comprising:
providing a pipeline laying vessel comprising a pipe support device comprising at least a plurality of fixed support surfaces and a plurality of moveable support surfaces,
suspending a pipeline at a free end by said plurality of fixed support surfaces,
providing a tubular member comprising multiple load bearing surfaces, the tubular member being supported by the plurality of movable support surfaces,
joining said tubular member to said pipeline,
disengaging the pipeline from the plurality of fixed support surfaces and lowering the combination of the pipeline and the pipe section which is joined thereto by the plurality of moveable support surfaces,
suspending the combination of the pipeline and the pipe section which is joined thereto by the plurality of fixed support surfaces.

The present invention also relates to a pipeline laying vessel comprising the pipe support device.

With the pipe support device, the method of laying a pipeline and the pipeline laying vessel, cost-effective pipelay is possible. Pipe-in-pipe lines with small annuluses can advantageously be laid.

The present invention further relates to a method of assembling a pipe assembly, the method comprising at least:
providing a tubular member,
providing a plurality of load bearing surfaces along the outer side of the tubular member, the load bearing surfaces being constructed and arranged in order to allow a substantial axial load to be imparted onto said tubular member, such that a pipeline to which said tubular member is connected can be suspended from a pipeline laying vessel, wherein a plurality of load bearing surfaces are provided for engaging a movable support device on the pipelay vessel and a plurality of load bearing surfaces are provided for engaging a fixed support device on the pipelay vessel.

In a preferred embodiment, the pipe assembly comprises one or more regular pipe sections, the tubular member and the one or more regular pipe sections being joined to one another in an end-to end relationship.

The pipe assembly allows cost-effective pipelaying and pipe-in-pipe systems with small annuluses.

The invention further relates to a support device configured to be used on board a pipelay vessel, the fixed or movable support structure comprising:
at least one tapered support surface constructed to engage a tubular member according to the invention, and/or
a plurality of support surfaces constructed to engage a tubular member according to the invention,
wherein the support device comprises outer dimensions which correspond to a known collar of a known pipe section used in a known J-lay method, the support device being configured to mimic said known collar.

The support device functions as an insert piece, allowing an existing pipe support device to be converted into an improved pipe support device without large costs.

With the improved pipe support device pipelines can be laid with single walls in a more cost-effective way and can lay a pipe-in-pipe line with a smaller annulus.

In a suitable embodiment, the support device is installable and removable from a pipe section.

The present invention also relates to a pipeline manufactured by any of the methods discussed herein and/or manufactured with the pipe support devices discussed herein and/or comprising any of the tubular or pipe assemblies discussed herein.

The claims and advantages will be more readily appreciated as the same becomes better understood by reference to the following detailed description and considered in connection with the accompanying drawings in which like reference symbols designate like parts, or parts with the same or similar function.

### BRIEF DESCRIPTION OF THE DRAWINGS

The invention will be further clarified by the following figures:

FIG. 1A: a side view, partially in cross-section, of a collar according to the prior art;

FIG. 1B: another side view, in cross-section, of a collar according to the prior art;

FIG. 2: a side view, partially in cross-section, of a collar with two load bearing elements known from the prior art;

FIG. 3: a partial side view in cross-section of a tubular member and a pipe support device according to the present invention;

FIG. 4A: a detail of FIG. 3 showing a part of the tubular member and the pipe support device according to the present invention;

FIG. 4B: a similar detail as FIG. 4A showing the forces which are imparted via the engaging surfaces of the tubular member and the pipe support device;

FIG. 4C: a detail of the stress distribution in the tubular member;

FIG. 4D: a side view of the stress distribution in the tubular member;

FIG. 4E: a detail of the stress distribution in the pipe support device;

FIG. 4F: a side view of the stress distribution in the pipe support device;

FIG. 5A: an isometric view of a support structure for a collar arrangement according to the present invention;

FIG. 5B: another isometric view of a support structure for a collar arrangement according to the present invention;

FIG. 6: a front view of the support structure of FIGS. 5A and 5B;

FIG. 7A: a side view in cross-section of a different embodiment of the present invention;

FIG. 7B: a side view in cross-section of another embodiment of the present invention;

FIG. 8; an isometric view with a cut-out part of the embodiment of FIG. 7;

FIG. 9: a side view in cross-section of a different embodiment of the present invention;

FIG. 10: a side view in cross-section of the embodiment of FIG. 9 with a part of a pipe support device;

FIG. 11: a side view in cross-section of the embodiment of FIG. 9 for use in an existing pipe support device;

FIG. 12: a side view in cross-section of a system of the prior art disclosed in US2006156530.

### DETAILED DESCRIPTION OF PREFERRED EMBODIMENTS

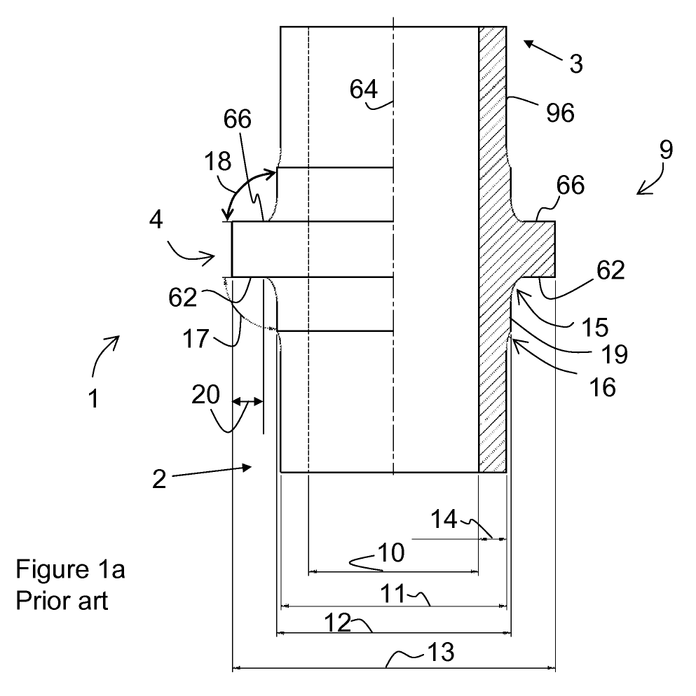

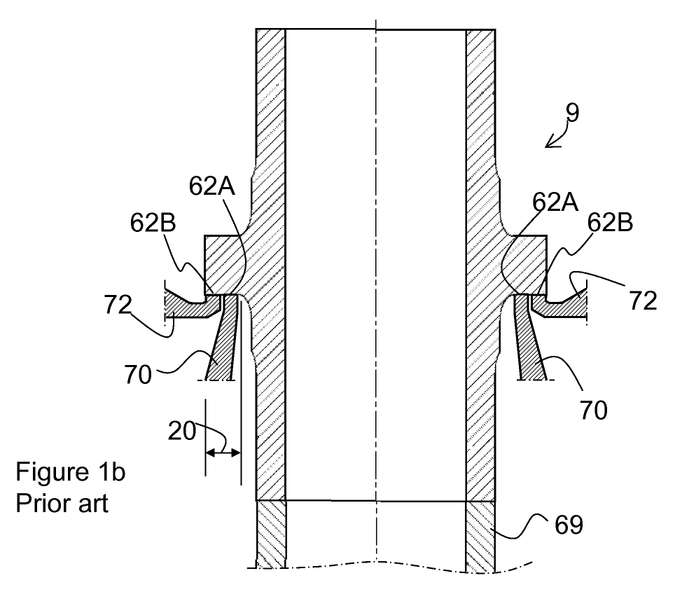

FIG. 1A shows a forging piece 9 as known from the prior art, comprising a collar arrangement 4. In use, the lower end 2 of the forging piece 9 of the prior art is welded in an end-to-end relationship with a regular steel pipe section (not shown in FIG. 1) or a number of steel pipe sections. The assembly of the forgings and the steel pipe sections is joined to a free end of a pipeline which is suspended from a pipelay vessel. Thus, the forging piece 9 with the collar 4 forms a ‘handle’ on the pipe assembly, with which handle the pipe assembly can be supported. After the pipe assembly is connected to the pipeline, the entire pipeline is supported via the forging piece 9 and the collar arrangement 4.

The left hand side of FIG. 1A shows a side view of the forging piece 9, the right hand side of FIG. 1A shows a cross section of the forging piece 9. The forging piece 9 has two ends 2, 3 with an outer diameter (OD) 11 and an inner diameter (ID) 10, defining a wall thickness 14. The ends 2, 3 of the forging piece 9 have a similar OD and ID as the pipeline section (not shown in FIG. 1) to which the end 2 is welded. The ID 10 of the forging piece 9 does not change over the length of the forging piece 9.

The maximum OD 13 of the forging piece 9 is larger than the OD 11 of the pipeline. The difference in wall thickness 14 is bridged via one or more fillets 15, 16. A fillet is a curved part of the outer wall 96 which forms a transition between two sections having two different outer diameters. The fillet is a generally of elliptical shape but other curvatures are also possible. The curved part 15, 16 is formed in order to prevent large stress peaks to occur.

The part 19 of the forging piece 9 between elliptical fillets 15, 16 is generally referred to as the shoulder of the collar.

The forging piece 9 has a load bearing element 4 (a collar) which comprises a load bearing surface 62. The load bearing surface 62 generally is an annular surface extending around the forging piece 9. The load bearing surface 62 generally extends at an angle 17 of typically 90 degrees with the longitudinal axis 64 of the forging piece 9 (and the pipeline which is connected to the forging piece), which is the direction that the load to be carried is working.

The upper side 66 of the load bearing element 4 also extends at an angle 18 of 90 degrees to the longitudinal axis 64. However, for the upper side 66 of the load bearing element 4 different angles are also known to be used.

The available width for a suspension means (not shown) to engage the load bearing surface 62 is indicated with numeral 20.

Turning to FIG. 1B, the forging piece 9 of the prior art is shown as it is used, i.e. after being welded to a steel pipe section 69. The pipe section 69 may typically have a length of 30-100 meter and be composed of several shorter pipe sections which are joined together. Shorter or longer pipe sections 69 may also be used. The pipe sections 69 and the forging piece 9 are generally welded together on deck of the pipe lay vessel.

In a J-lay system which uses collars, two pipe support means 70, 72 are generally provided, i.e. a static hang off means 70 (also known as a hang-off table) for suspending the pipeline from the pipelay vessel and a pipe lowering means 72 with which the pipeline may be lowered. The pipe lowering means 72 is connected to a hoist winch and generally movable along the height of the J-lay tower. The hang-off means 70 and 72 work together in forming and lowering the pipeline as is known from many publications. Both the support means 70 and 72 should be able to carry the full weight of the suspended pipeline.

The width 20 of the collar 4 is designed to accommodate both the suspension means which are used, i.e. the static hang off means 70 and the pipe lowering means 72. Thus, both suspension means 70, 72 engage on the same load bearing surface 62. One suspension means 70 engages surface part 62A and one bearing means engages surface part 62B. Surface part 62b extends around surface part 62A.

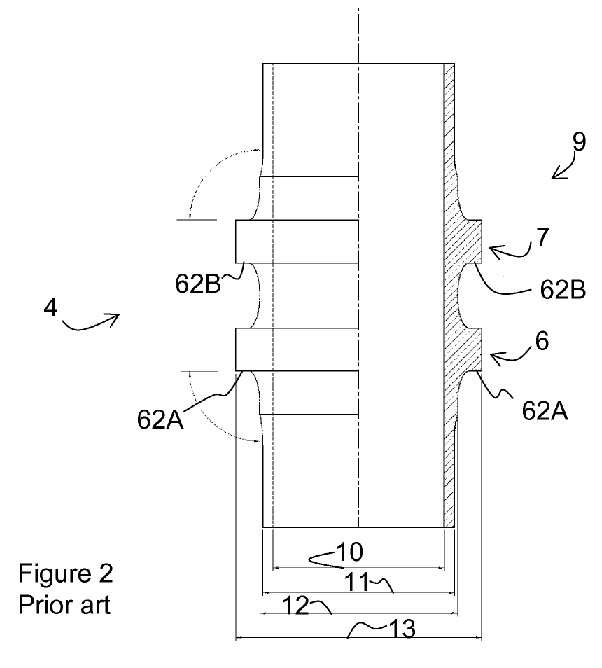

FIG. 2 shows another embodiment known from the prior art. Forging piece 9 comprises two bearing elements 6, 7. The bearing elements 6, 7 are formed as collars. The collar 6 is used to hang off the pipeline on a stationary hang off means 70 (not shown), and collar 7 is used to lower the pipeline with a movable support 72 (not shown).

This embodiment allows the total OD 13 of the load bearing elements 6, 7 to be smaller than the total OD 13 of the collar 4 of the embodiment shown in FIG. 1A and 1B. This is due to the fact that surface part 62B is not arranged around the surface part 62A as in the embodiment of FIGS. 1A and 1b, but is arranged above surface part 62B. Surface part 62B thus can have a smaller outer diameter in the embodiment of FIG. 2 than in the embodiment of FIGS. 1A, 1B. The total pipe load is generally carried by one bearing element 6 or 7 at a time. No load sharing is required.

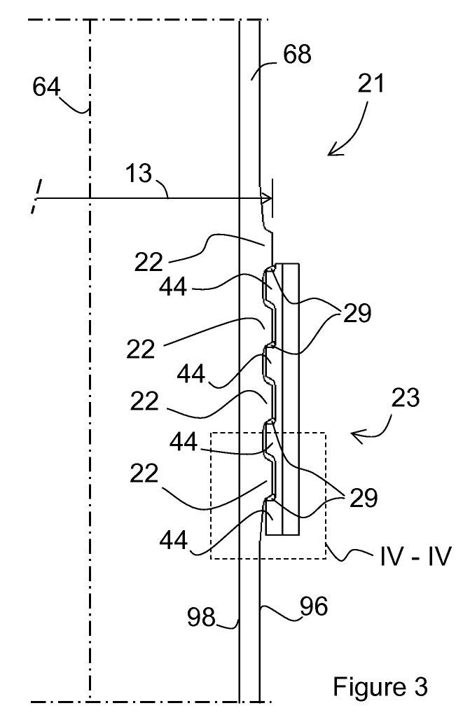

FIG. 3 shows a cross section of a bearing arrangement 21 (or collar arrangement 21) according to the present invention. The tubular member (or pipe) 68 is an inner pipe of a pipe-in-pipe line. The pipe 68 comprises four bearing elements 22. A support structure 23 is shown in cross section. The support structure 23 is part of a pipelay system. The support structure 23 comprises four supports 44 which each engage a bearing element 22 on the pipe 68.

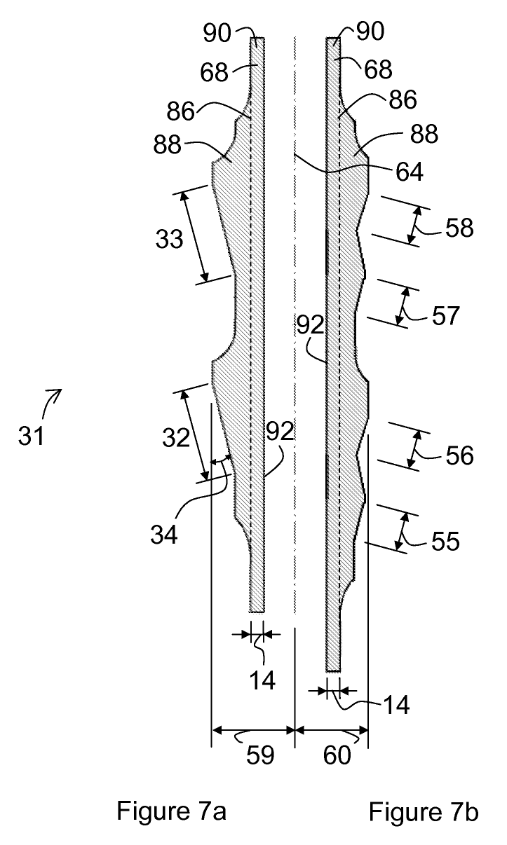

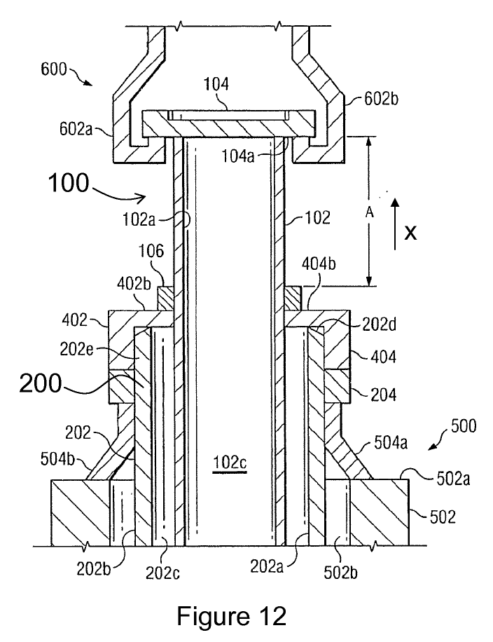

The support structure 23 is constructed in order to support the inner pipe 68 after it is pulled upwards relative to the outer pipe (not shown) and under tension. Reference is made to FIG. 7g of US 2006156530 which is included as FIG. 12. The four bearing elements 22 replace the collar 106 of the embodiment of FIG. 12. The support structure 23 replaces the supports 402, 404 of FIG. 12.

The shown embodiment of FIG. 3 comprises four bearing elements 22 and four supports 44. Solutions with a different number of bearing elements are also possible as well. For instance, 2, 3, 5, 6, 7, 8 or a different number of bearing elements 22 and supports 44 may be used.

The load bearing surfaces 22 are annular surfaces which extend around the outer side of the tubular member 68.

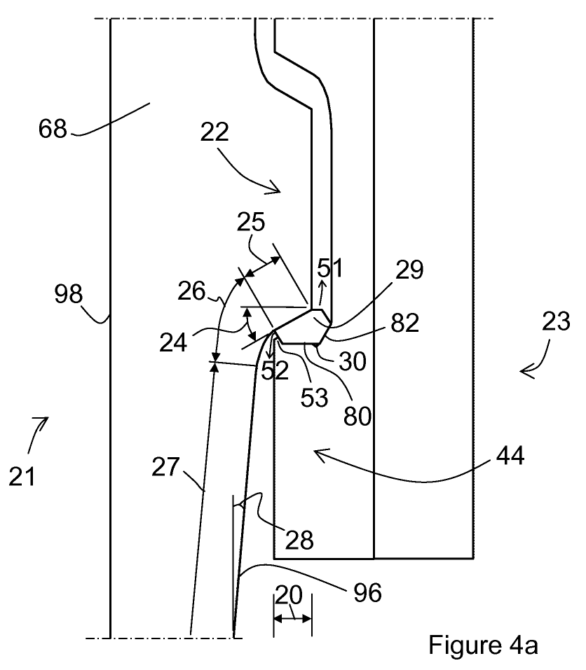

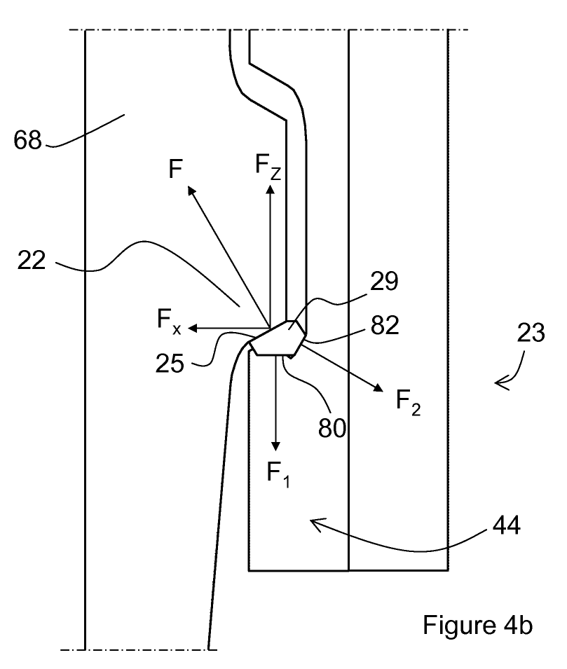

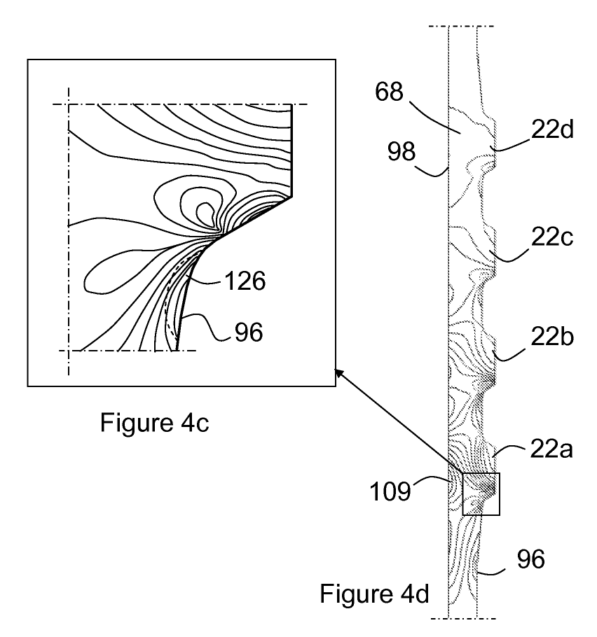

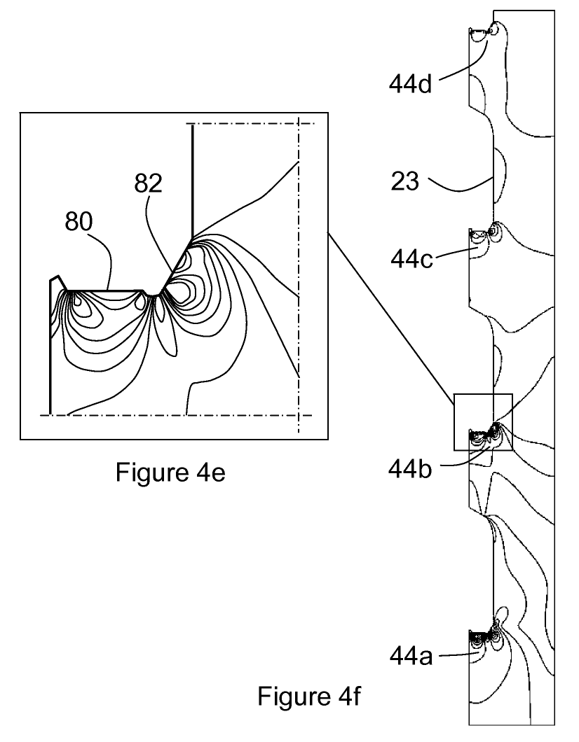

Turning now to FIGS. 4A and 4B, which show section IV-IV of FIG. 3 in more detail. In use, the total load is divided over the four supports 44 and the four bearing elements 22. Because of the load distribution, a bearing area 25 of each bearing element 22 can be significantly smaller than the bearing area of the collar 106 which is shown in FIG. 12. This allows a smaller outer diameter 13 of the inner pipe 68 in comparison with the embodiment of FIG. 12. The smaller outer diameter 13 in turn results in the possibility of a smaller annulus between the inner pipe 68 and the outer pipe (not shown). This results in a more cost-effective solution.

Similarly, a bearing area 80 of each support 44 can also be smaller than the bearing area of the prior art. The presented solution allows a considerable force to be exerted on the pipe 68 by the support structure 23 and still keep the dimensions of the support structure 23 relatively small.

A section of a part of the improved collar arrangement 21 is shown. A part of the collar arrangement 21 is shown which has one complete bearing element 22. Further, a corresponding part of the support structure 23 is shown.

The collar arrangement 21 and the support structure 23 will generally not align perfectly with one another due to size tolerances in both elements, that must be allowed in the fabrication process. This may lead to a situation in which the entire load is transferred to the pipe via a single support 44 and a single collar 22. This is disadvantageous and may lead to damage. In order to prevent this and in order to compensate for the size tolerances, deformable members 29 are inserted between bearing elements 22 and support structure 23. The deformable members may be yield rings 29.

The deformable members 29 are made from a material with a lower resistance against deformation than the support collar 22 and the support structure 23. The difference in dimensions will thus be absorbed by deformation of the deformable members 29 until each collar 22 carries a more or less equal part of the total load exerted on the pipe.

Bearing area 25 is positioned under an angle 24 to a direction perpendicular to the pipeline longitudinal axis 64 (not shown). Preferably, this angle is between 20 and 40 degrees, which amounts to an angle of 50-70 degrees with respect to the longitudinal axis of the tubular member.

Preferably, the angle is around 30 degrees with respect to a plane which is at right angles with the pipe axis 64, which amounts to an angle of about 60 degrees with the pipe axis 64.

The angular orientation enables a smoother transition from the bearing area 25 to the longitudinal pipe wall. This significantly reduces the stress concentrations in the curved section 26. In turn the angular orientation introduces radial (hoop) stresses in the pipe wall, however the peak stress levels can be reduced when compared to a collar known from the art.

Generally, the bearing area 25 is continuous around the pipe 68. It is also conceivable that intermittent surface areas 25 are used.

An elliptical fillet 26 provides a transition zone between bearing area 25 and a straight section 27 of the outer wall 74 of the pipe 68. The straight section 27 provides the transition in wall thickness 14 between the end of the elliptical fillet 26 and the nominal pipe wall thickness 14. The straight section 27 extends under an angle 28 with the pipeline longitudinal axis 64. This angle 28 is preferably between 2 and 10 degrees, more preferably around 5 degrees. The section 27 is constructed in order to further reduce stress concentrations in the pipe 68.

The yield ring 29 is inserted between the bearing element 22 and the support structure 23. A small indentation 30 is made in the support structure in order to avoid stress concentrations in the corner area of the support structure. Since yield ring 29 is constructed to yield, the material needs some room to displace into. The present design provides room for the material of the yield ring 29 to move in the direction of arrows 51 and 52. The deformation of the deformable members 29 is foreseen to be in the order of 0.05-0.3 mm.

The yield ring 29 engages the support 44 at surface areas 80, 82. The yield ring 29 is kept in place in the support structure 23 via a small notch 53 which extends in a discontinuous fashion around the circumference of the support structure 23. The parts of the circumference where no notch 53 is present provide access to the yield ring 19. Access to the yield ring may be necessary to replace it after a certain time of use, because the mechanical properties of the yield ring 29 may degrade after a certain time, resulting in a need to replace the yield ring 29. Because the yield ring 29 may become fixed to the support structure 23, a chisel may be necessary to remove the yield ring 29. The discontinuities in the notch 53 provide access to the yield ring 29 for the chisel.

The discontinuous notch 53 may be provided with a chisel, when it has to be removed after use.

The bearing area 25 of the yield ring 29 may be equipped with a pattern of small ribs (not shown) so it can be easily seen when a ring has been used beyond its yield point in order to avoid use after yielding.

FIG. 4B shows the force F which is exerted on the pipe 68 via the surface area 25. The force F comprises a longitudinal component Fz and a radial component Fx. The longitudinal component Fz leads to an axial stress in the pipe 68. The radial component Fx induces a hoop stress in the pipe 68. The force F acts on support 44 via F1 acting on surface area 80 and F2 acting on surface area 82.

FIG. 4c and 4d show the stress concentrations in the pipe 68. It can be seen that axial stress peaks occur at the outer wall of the pipe 68, directly underneath a lower bearing element 22a. The area with axial stress peaks is delimited with a dashed line and indicated with reference numeral 126.

It can also be seen that the stress concentrations decrease in an upward direction, such that in bearing element 22d, the stresses are lower than in the lower bearing element 22a. This decrease in stresses in upward direction allow a greater freedom of form in the upper bearing element 22d than in the lower bearing element 22a. It is possible that the upper bearing element 22d has a different form than the lower bearing element 22a. For instance, the upper bearing element 22d may be provided with a surface 25 which is not tapered, but which extends at an angle of 90 degrees to the pipe axis 64. This may also apply for the bearing element 22c. It is also possible that the form of the bearing element varies with each bearing element, as viewed in an upward direction.

This provides an advantage in that the support structure 23 can be lighter. If the upper bearing elements 22 do not taper, than the support structure 23 does not need to be configured for accommodating a lateral force from that bearing element 22.

Thus, the present invention also relates to a tubular member which comprises one or more tapering load bearing surfaces and one or more non-tapering load bearing surfaces.

The present invention also relates to a support structure configured for supporting a tubular member which comprises one or more tapering load bearing surfaces and one or more non-tapering load bearing surfaces.

It can also be seen that the hoop stresses have a maximum in a different area, i.e. in the area 109 near the inner wall 98 in the region of the first support 22a.

FIGS. 4e and 4f show the stress concentrations in the support structure 23. It can be seen that the stress peaks occur at the support surfaces 80 and 82 of the lowest support 44a. The stresses decrease with each support 44 in the upward direction and are at a minimum at the upper support 44d.

The specific form of the bearing element 22 is constructed an optimised in such a way that stress peaks due to axial and hoop stresses are maintained below an acceptable level as can be seen from FIGS. 4c-4f.

### Single Wall Pipe

The embodiment of FIGS. 3, 4A-4F may be used in a pipe-in-pipe situation as discussed above. However, it is also possible to use the embodiment of FIGS. 3, 4A-4F for a single wall pipeline. This enables a single wall pipe 69 of a pipe-in pipe system to be used without a thick forging piece 9 as is necessary in the embodiment of FIGS. 1A and 1B. Instead, the pipe 68 shown in FIGS. 3, 4a and 5b may be formed from a smaller forging or more preferably thick-walled pipe 68 having a same inner diameter as the regular pipe sections 69 used in a J-lay method, but with a larger outer diameter 13 and thus a larger wall thickness 14.

The collar arrangement 21 with the load bearing elements 22 can be machined from the thick walled pipe 68 by conventional machining methods. A part of the pipe material is removed, until the collar arrangement 21 emerges from the material. Additional advantage of the use of thick walled pipe is that because the forging piece 9 is obviated, no separate welding procedure for forging to pipe is required.

For a single wall pipeline, the bearing elements 22 will be constructed to cooperate with a fixed pipe support 70 and a movable pipe support 72. To this end, it is possible that 2, 3 or 4 supports 22 are provided for the fixed pipe support 70 and that 2, 3 or 4 bearing elements are provided for the movable pipe support 72. A different number is also possible

Thus the bearing elements 22 replace the single collar 4 of the embodiment of FIG. 1A, 1B and/or the double collar of the embodiment of FIG. 2.

The angle 24 of the bearing surface 25 has a same advantage in single wall pipelines as in pipe-in-pipe lines, i.e. the reduction of stress concentrations.

In a suitable embodiment, a distinguishing difference between the presented solution and the embodiments of FIGS. 1A, 1B and 2 is the angled support surfaces 25 and/or the use of a plurality of support surfaces 25 above one another for both the static pipe support 70 as the movable pipe support 72. In contrast, the embodiment of FIG. 2 uses a single support surface for the static clamp 70 and a single support surface for the movable clamp 72.

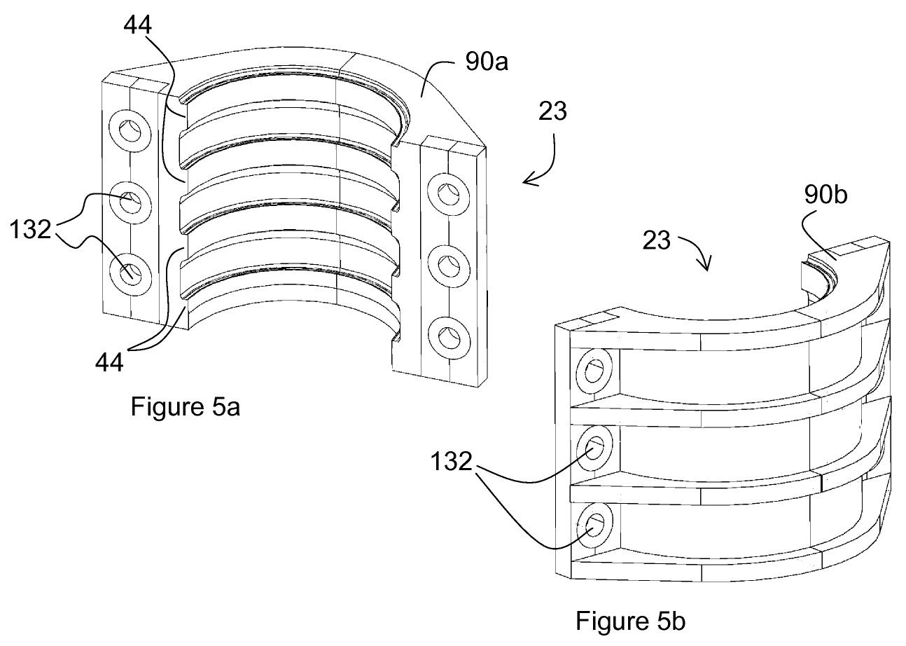

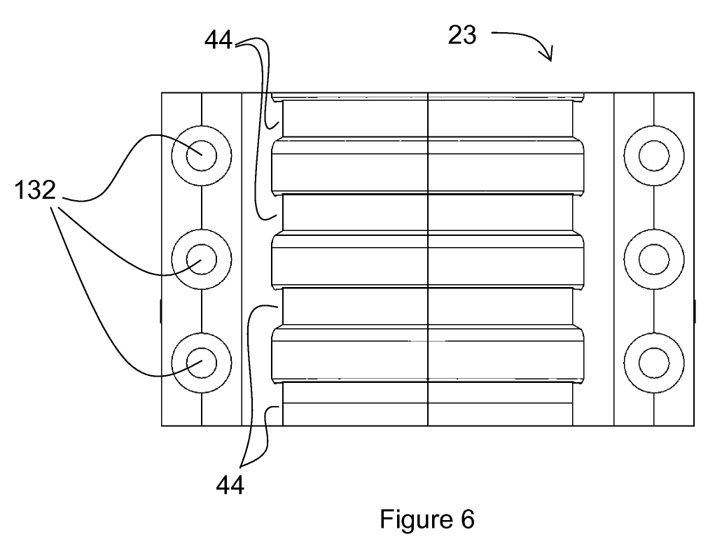

FIGS. 5A and 5B show isometric views of a possible embodiment of the support structure 23. A view on the inner side is shown in FIG. 5A and a view on the outer side is shown in FIG. 5B. The shown embodiment comprises two half shells 90A, 90B. However, solutions with more sections are also conceivable. The two halves 90A, 90B can be connected together in order to fully enclose the collar arrangement 21, for instance via bolts (not shown) through holes 132. The yield rings 29 are not shown in FIGS. 5A and 5B.

A hingeable connection between the two half shells 90A, 90B may be used.

FIG. 6 shows a front view of the inside of a half shell of support structure 23 as shown in FIG. 5. The yield rings are not shown in FIG. 6.

FIG. 7A shows an alternative embodiment of a pipe 68 comprising a collar arrangement 31 (or bearing arrangement 31) that is suitable for a reduced wall thickness at the load bearing area. This design is based on a wedge-type of support by a stationary pipe support 70 (not shown) and a movable pipe support 72 (not shown). FIG. 7A shows a bearing arrangement 31 comprising two bearing areas 32 and 33. The bearing area 32 may be used for a stationary support means 70 and the bearing area 33 may be used for a movable support 72 or vice versa.

The angle 34 of the bearing areas with respect to the longitudinal axis 64 is preferably between 2 and 10 degrees. Due to this steep angle 34, a considerable amount of horizontal force relative to the vertical force will be developed within the pipe 68. This will result in a substantial hoop stress in the pipe wall. Also, the total length of the assembly of FIGS. 7A and 7B will be longer than for the embodiment shown in FIGS. 3 through 6.

By varying the angle of the load bearing areas 32, 34, 55, 56, 57, 58, the bearing arrangement can be optimized to suit the available space in the installation system, provided pipe properties and tensions allow for this.

The dashed line 86 indicates a division in the pipe 68 of two regions i.e. a wall region 90 and a collar region 88. The wall region 90 is the region defined by the normal wall thickness 14 of the pipe 68. In the wall region 90, axial, radial and hoop stresses should be maintained below the yield point of the pipe 68, as expressed in the Von Mise stress.

The Von Mises stress is a scalar stress value that can be computed from the stress tensor. A material is said to start yielding when its von Mises stress reaches a critical value known as the yield strength. The von Mises stress is used to predict yielding of materials under any loading condition from results of uni-axial tensile tests. The von Mises stress satisfies the property that two stress states with equal distortion energy have equal von Mises stress.

In the collar region 88, the stresses may exceed the yield point in some embodiments of the invention.

The collar region 88 is formed in such a way that the concentrated stresses in the bearing areas 32, 33 which are induced by a load acting on said bearing areas 32, 33 are reduced to acceptable levels before reaching the wall region 90. The reduction takes place by dispersion of the stresses over a greater area in the wall of the pipe 68.

The hoop stress typically peaks at the inner side 92 of the pipe 68.

The maximum diameter 59 of the pipe 68 of the embodiment of FIG. 7A is smaller than the diameter of the embodiment of FIGS. 1A and 1B. This feature allows for the use of a thick walled pipe section for pipe 68, instead of a forging 9 as is necessary for the embodiment of FIGS. 1A and 1B. This, the advantage of a single weld procedure is obtained as is discussed hereinabove.

In FIG. 7B, the same principle is shown, however with the concept of load sharing. Instead of one bearing area 32, 33 per support means or support there are more than one area, wherein FIG. 7 shows two. Bearing areas 55 and 56 are constructed to be engaged by a fixed support 70. Bearing areas 57 and 58 are configured to be engaged by a movable support 72. Together, bearing areas 55, 56, 57 and 58 replace bearing areas 32 resp. 33. The result of this design is that a maximum radius 60 of the embodiment of FIG. 7B may be smaller than maximum radius 59 of the embodiment of FIG. 7A. A further division of the bearing area in more than two sections may lead to further reduction of overall outer diameter 60. The total length of the assembly 31 is likely to increase for a reduced wall thickness.

An advantage of the embodiment of FIG. 7B over the embodiment of FIG. 7A is that a pipe with a thinner wall thickness 14 may be used for machining the bearing areas 56-58.

Another aspect of the embodiments of FIG. 7A, 7b is that extreme stress concentrations may occur on the inside of the pipe wall, which is not the case in the embodiment shown in FIGS. 3 through 6.

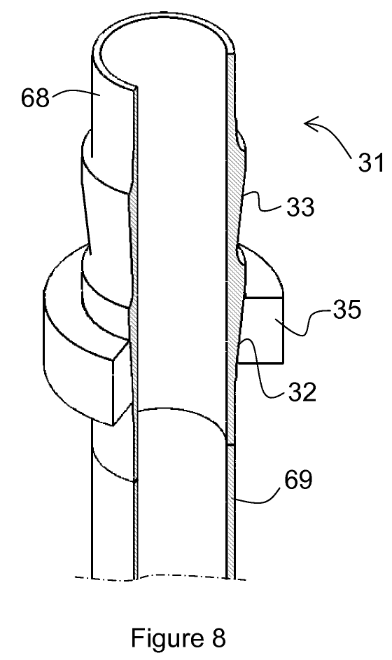

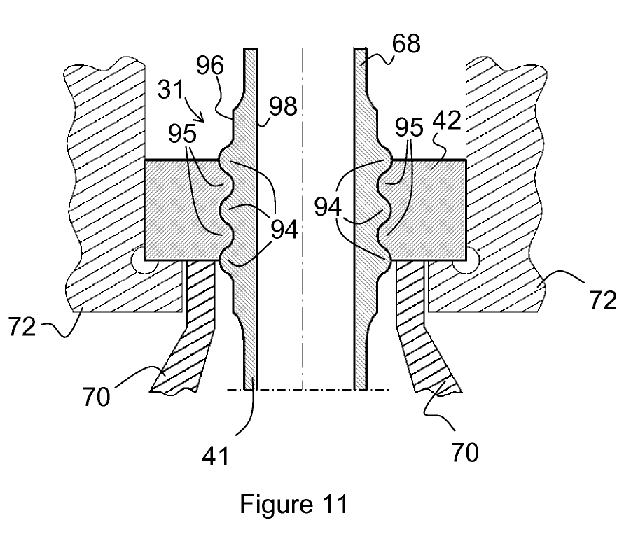

FIG. 8 shows an isometric, partly open view of the embodiment of FIG. 7A. The pipe 68 having a collar arrangement 31 is supported by a support construction 35. This may be a hang-off table but may also comprise a re-usable bearing device which is hung off on a conventional hang-off table. A similar principle for a different embodiment is shown in figure 11. A movable support (not shown) can engage on bearing area 33.

It is shown in FIG. 8 that the pipe 68 having collar arrangement 31 is connected to a pipe 69. The pipe 69 is a regular pipe section used for J-lay. The pipe section 69 may itself be composed of two, four or six shorter pipe sections which are joined together prior to the joining of pipe 69 to a pipeline, as is customary in J-lay.

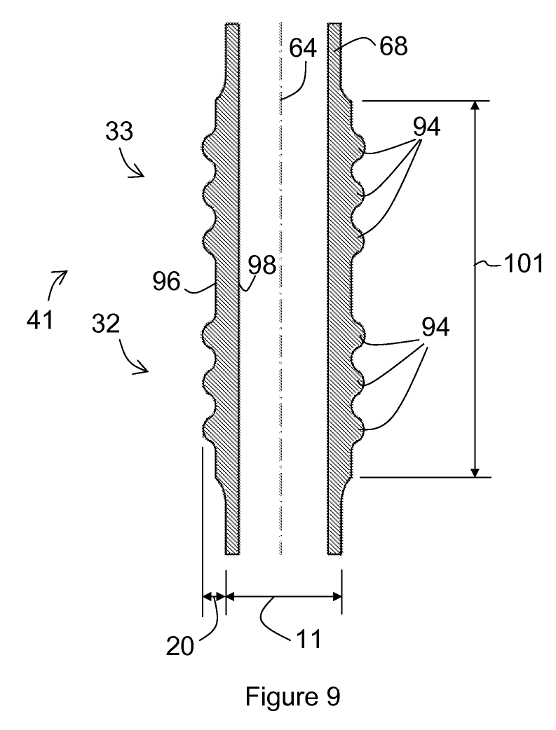

FIG. 9 shows yet another embodiment of the present invention. The wedge shaped form of the embodiments of FIGS. 7A and 7B is now replaced by rounded threads 94. The threads may also be rims or ridges. By increasing the number of rounded threads 94, the total bearing area can be increased. Thus, a force which is to be applied per thread 94 can be reduced. It is further possible to reduce the width 20 (or thickness) of the threads 94 if more threads are used. Thus, the additional thickness 20 outside the nominal pipe OD 11 can become smaller, although a greater length 101 of pipe will be required to transfer the required force onto the pipe 68.

The threads 94 may be formed by depositing welding beads onto a regular pipe section 69. In this way, it is possible to do without a forging piece 9 and also without a thick walled pipe section. In an exemplary embodiment, a regular pipe section may be used, and with a regular welding machine a series of regular welding beads are deposited onto the outer wall 98 of the pipe 68.

In another suitable embodiment a thick walled pipe 68 is used. Instead of removing a part of the material of the pipe 68, the threads 94 are formed onto said pipe. In this way, a thick walled pipe can be used with a smaller wall thickness than otherwise would be required.

The form of the threads 94 on the surface may be comparable to semi-circles. Also, a sinus-shape is possible or a different curvature.

FIG. 9 shows an embodiment where two load bearing regions are defined, one load bearing region 32 for a stationary support 70 (not shown) and one load bearing region 33 for a movable pipe support 72 (not shown).

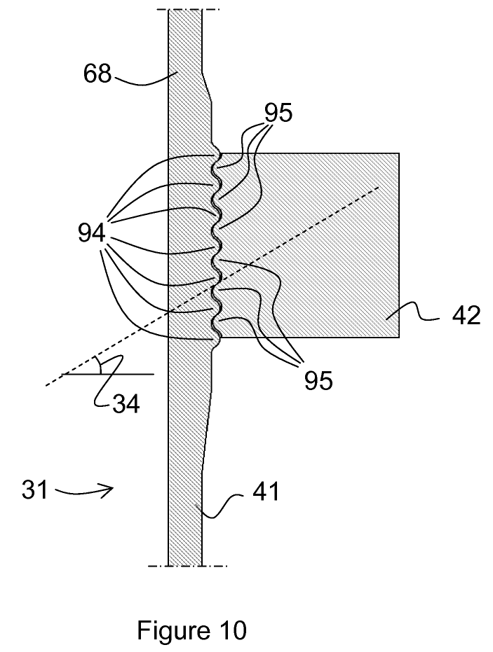

FIG. 10 shows a cross section of a part of a pipe 68 having a bearing arrangement 31. A support construction 42 comprises threads or rims 95 which engage the rounded threads 94 of the pipe 68 to transfer the pipe load. Load bearing takes place over the contact areas between bearing arrangement 31 and support construction 42. Misalignments between these two components can lead to high local stresses and should be well controlled. It is possible to use deformable members such as yield rings (not shown) in this embodiment as well.

The contact surfaces typically extend at an angle 34 to a plane which extends at right angles to the pipe axis 64. The angle 34 may be between 20 and 40 degrees.

If the threads 94 are very small, it is possible to use an ordinary pipe section 68 onto which threads 94 are welded with a welding machine by forming welding beads on the pipe 68. The threads may be formed by depositing welding material on the pipe section 68. In this way, the pipe sections 68 that are stored on board may all have the same size and shape regardless of whether the pipe sections are eventually used as an upper pipe section of a six-joint or quad-joint or another pipe section.

It is also possible to provide a screw thread onto the outer wall of the pipe 68.

In a currently employed J-lay method, six pipe joints of about 12 meter are welded into a pipe joint of about 73 meter. A forging of about 0.5 to 1 meters is then welded to the six-joint pipe. The 73 meter pipe joint is then welded to the pipeline which is supported by the hang-off table on the pipelay vessel.

In the present invention, the forging can be obviated. Next, the upper pipe section of the six pipe sections would need to have a thicker wall thickness in several of the shown embodiments. However, in an exemplary embodiment, i.e. if the embodiment of FIG. 10 is used with very small threads 94, then all pipe sections may have the same wall thickness, the same inner diameter and het same outer diameter.

FIG. 11 shows an embodiment wherein the pipe 68 has only one load bearing arrangement 31. A support construction 42 can engage on the load bearing arrangement 31. The support construction 42 may adopt the dimensions of a traditional collar 4 of the embodiment FIGS. 1A and 1B in order to make it possible to use the innovative load bearing principle in an existing pipelay system having with a stationary 70 and a movable pipe support 72. The existing pipelay system would not need any modification in this way. The support construction 42 may be re-usable.

Referring to FIG. 12, the known method of US2006156530 comprises translating an inner tubular member 100 in a direction A relative to the outer tubular member 200. The lowering clamp 600 is moved in direction X, and due to the engagement of support arms 602a and 602b with pulling head 104, inner tubular member 100 is translated over a distance A in direction X through the passageway 202c on outer tubular member 200 until inner tubular member collar 106 is positioned outside of passageway 202c and adjacent the top end 202e of the outer tubular member 200 including beveled surface 202d.

A plurality of brackets 400 includes a bracket 402 and a bracket 404. Bracket 402 is substantially L-shaped and includes a collar engaging surface 402a and a collar support surface 402b. Bracket 404 is substantially L-shaped and includes a collar engaging surface 404a and a collar support surface 404b. In an alternative embodiment, the plurality of brackets 400 may be combined to provide an annular bracket with a top surface including collar support surfaces 402b and 404b and a bottom surface including collar engaging surface 402a and 404a.

Translating the inner tubular member 100 in direction A and into the position illustrated in FIG. 12 applies a tensile force to inner tubular member 100, thereby creating force distributions in the inner tubular member 100 and the outer tubular member 200.

The brackets 402, 404 support inner tubular member 100 in its translated position.

It will be obvious to a person skilled in the art that numerous other changes in the details and the arrangement of the parts may be varied over considerable range without departing from the spirit of the invention and the scope of the claims.

For instance, straight and circular bearing areas have been shown. Other shapes may also be possible for instance triangular, parabolic, etcetera.

Also, the shown bearing areas are annular, but also intermittent load bearing surfaces are possible.

It will be clear that the concept of the angled load bearing surfaces and the concept of the plurality of load bearing surfaces may be combined, including combinations of all the embodiments of the two concepts.

What is claimed is:

1. A tubular member configured to be supported by a pipe support device of a pipelay system on board a pipelay vessel,
the tubular member comprising at least one load bearing surface which is formed along the outer side of the tubular member,
the load bearing surface being configured such that a weight of a pipeline suspended from the vessel can be carried via the at least one load bearing surface,
wherein the at least one load bearing surface tapers outwardly with respect to a main longitudinal axis of said tubular member.

2. The tubular member according to claim 1, comprising a plurality of tapered load bearing surfaces which are provided at a distance from one another, the load bearing surfaces constructed such that in use the total axial load to be transferred from the pipe support device onto the tubular member is distributed over the respective load bearing surfaces.

3. The tubular member according to claim 1, wherein a least one load bearing surface extends at an angle of 50-70 degrees with respect to a main longitudinal axis of the tubular member.

4. The tubular member according to claim 1, wherein said tubular member is manufactured from steel.

5. The tubular member according to claim 1, having a length of between 0.5 and 14 meter and intended to be joined to a longer pipe section which is to be laid in a J-lay method.

6. The tubular member according to claim 5, comprising:
a coupling region at a coupling end of the tubular member, the coupling end being constructed to be connected to said pipe section, wherein said coupling region has a coupling inner diameter and a coupling outer diameter, and
a support section comprising the at least one load surface, said support section having a different outer diameter than the coupling section.

7. The tubular member according to claim 6, wherein a transition of the difference in the outer diameter between the coupling section and the support section is bridged via a bridging section which comprises a curved section.

8. The tubular member according to claim 1, wherein the at least one load bearing surface forms at least partially a conical surface.

9. The tubular member according to claim 1, wherein the at least one load bearing surface is an annular surface extending around the outer side of the tubular member.

10. The tubular member according to claim 1, wherein said at least one support surface extends at an angle to the longitudinal axis of the pipeline between 2 and 10 degrees, preferably around 5 degrees.

11. The tubular member according to claim 1, comprising a plurality of rims formed on the outer wall of the tubular member, wherein a part of the surface of each rim forms said load bearing surface.

12. The tubular member according to claim 11, wherein the rims are welding beads deposited on the outer wall of the tubular member.

13. A pipe support device constructed and arranged to be provided as part of a pipelay system on board a pipelay vessel, the pipe support device configured to carry an axial load imparted by a tubular member according to claim 1 comprising at least one tapered load bearing surface, the pipe support device comprising at least one support surface which tapers outwardly at an angle to an axis which in use is coaxial with a longitudinal axis of the tubular member, the at least one support surface constructed to in use engage the load bearing surface of said tubular member directly or indirectly via a deformable intermediate member, the support surface being configured such that a weight of a pipeline suspended from the vessel can be carried via the at least one support surface.

14. The pipe support device according to claim 13, comprising at least one deformable member which is positioned between the at least one support surface and the load bearing surface of the pipe for substantially limiting stress peaks in the material due to size tolerances of the at last one support surface or the at least one load bearing surface.

15. The pipe support device according to claim 13, wherein the tapering angle between the at least one support surface and the longitudinal axis is between 50 and 70 degrees.

16. The pipe support device according to claim 13, comprising a plurality of tapered support surfaces which are provided at a distance from one another, the support surfaces being constructed such that in use the total axial load to be transferred from said tubular member is distributed over the support surfaces.

17. The pipe support device according to claim 13, comprising at least one fixed support surface and at least one moveable support surface the fixed and moveable support surface being arranged to cooperate in forming and lowering a pipeline.

18. The pipe support device according to claim 13, wherein the at least one support surface is at least partially a conical surface.

19. The pipe support device according to claim 13, wherein the at least one support surface is an annular surface.

20. The pipe support device according to claim 13, wherein the at least one support surface extends at an angle to the longitudinal axis of the pipeline between 2 and 10 degrees, preferably around 5 degrees.

21. The pipe support device according to claim 13, comprising a plurality of notches, wherein a part of each notch forms said support surface, the notches being constructed and arranged to engage a plurality of rims formed on the outer wall of the tubular member, wherein a part of the surface of each rim forms said load bearing surface.

22. The pipe support device according to claim 13, comprising a plurality of support surfaces, the support surfaces being constructed such that they can engage welding beads deposited on the outer wall of the tubular member.

23. A method of laying a pipeline, the method comprising at least:
providing a pipeline laying vessel comprising a pipe support device constructed and arranged to be provided as part of a pipelay system on board a pipelay vessel, the pipe support device configured to carry an axial load imparted by a tubular member according to claim 1 comprising at least one tapered load bearing surface, the pipe support device comprising at least one support surface which tapers outwardly at an angle to an axis which in use is coaxial with a longitudinal axis of the tubular member, the at least one support surface constructed to in use engage the load bearing surface of said tubular member directly or indirectly via a deformable intermediate member, the support surface being configured such that a weight of a pipeline suspended from the vessel can be carried via the at least one support surface,
providing a tubular member according to claim 1,
supporting the tubular member by the pipe support device.

24. The method of claim 23, the method comprising:
providing a pipeline laying vessel comprising the pipe support device of claim 13, said pipe support device comprising at least one fixed tapered support surface and at least one moveable tapered support surface,
suspending a pipeline at a free end by said at least one fixed support surface,
providing a tubular member according to claim 1, the pipe section being supported by the movable tapered support surface,
joining said tubular member to said pipeline,
disengaging the pipeline from the at least one fixed tapered support surface and lowering the combination of the pipeline and the pipe section which is joined thereto by the at least one moveable tapered support surface,
suspending the combination of the pipeline and the pipe section which is joined thereto by the at least one fixed support surfaces.

25. The method according to claim 23, wherein said pipeline comprises an inner pipeline and an outer pipeline of a pipe-in-pipe line, wherein at least the inner pipeline comprises a tubular member according to claim 1, and wherein the tapered support surface engages the load bearing surface of the inner pipeline, and wherein the inner pipeline is moved upwards relative to the outer pipeline.

26. A pipeline laying vessel comprising the pipe support device of claim 13.

27. A method of assembling a pipe assembly, the method comprising at least:
providing a tubular member,
providing at least one tapered load bearing surface on said tubular member, the load bearing surface being arranged and constructed to allow a pipeline to which said tubular member is connected to be suspended from a pipeline laying vessel.

28. The method according to claim 27, wherein the tubular member is joined to at least one regular pipe section in an end-to-end relationship prior to the joining of the assembly of the tubular member and the at least one pipe section to a pipeline suspended from a pipelay vessel.

29. The method according to claim 28, wherein said tubular member has a substantially same inner diameter as the regular pipe section, and wherein said tubular member has a greater outer diameter than said regular pipe section, and wherein the at least one tapered support surface is formed by removing a part of the material of the tubular member.

30. The method according to claim 28, wherein said tubular member and said pipe section are manufactured from a same material, in particular steel.

31. The method according to claim 27, the method further comprising:
providing rims of strong material around the outer wall of said tubular member, the rims being constructed and arranged to function as a load bearing surface for bearing a load which is imparted by a support surface of a pipelay vessel on the pipe assembly in order to suspend a pipeline from said pipelay vessel.

32. The method according to claim 31, wherein said rims are welding beads of weld material which are deposited onto the outer surface of said pipe, the welding beads forming the load bearing surfaces.

33. The method according to claim 31, wherein the rims are endless loops extending along said outer wall of said tubular member.

34. A pipe assembly of a tubular member according to claim 1 and one or more regular pipe sections, the tubular member and the one or more regular pipe sections being joined to one another in an end-to end relationship.

35. A tubular member configured to form part of a pipeline which is laid by a pipeline laying vessel, the tubular member comprising a plurality of load bearing surfaces which are formed along the outer side of the tubular member, the load bearing surfaces being constructed and arranged in order to allow a substantial axial load to be imparted onto said tubular member, such that a pipeline to which said tubular member is connected can be suspended from a pipeline laying vessel, wherein a plurality of load bearing surfaces are provided for engaging a movable support device on the pipelay vessel and a plurality of load bearing surfaces are provided for engaging a fixed support device on the pipelay vessel.

36. The tubular member according to claim 35, comprising a plurality of rims formed on the outer wall of the tubular member, wherein a part of the surface of each rim forms said load bearing surface.

37. The tubular member according to claim 36, wherein the rims are welding beads deposited on the outer wall of the tubular member.

38. The tubular member according to claim 35, wherein the plurality of load bearing surfaces for engaging the movable support device taper outwardly with respect to a main longitudinal axis of said tubular member, and wherein the plurality of load bearing surfaces for engaging the fixed support device taper outwardly with respect to a main longitudinal axis of said tubular member.

39. A pipe support device according claim 35, wherein said support surfaces comprise a removable layer of material with a lower resistance against deformation than the support device itself.

40. A pipe support device constructed and arranged to be provided on board a pipelay vessel, the pipe support device configured for carrying an axial load imparted by a tubular member according to claim 35, the pipe support device comprising a plurality of fixed support surfaces and a plurality of moveable support surfaces, wherein the fixed and moveable support surfaces are configured to cooperate in laying the pipeline.

41. A method of laying a pipeline, the method comprising:
providing a pipeline laying vessel comprising the pipe support device of claim 40,
said pipe support device comprising at least a plurality of fixed support surfaces and a plurality of moveable support surfaces,
suspending a pipeline at a free end by said plurality of fixed support surfaces,
providing a tubular member according to claim 1, the pipe section being supported by the plurality of movable support surfaces,
joining said tubular member to said pipeline,
disengaging the pipeline from the plurality of fixed support surfaces and lowering the combination of the pipeline and the pipe section which is joined thereto by the plurality of moveable support surfaces, and
suspending the combination of the pipeline and the pipe section which is joined thereto by the plurality of fixed support surfaces.

42. The pipeline laying vessel comprising the pipe support device of claim 40.

43. A method of assembling a pipe assembly, the method comprising at least:
providing a tubular member,
providing a plurality of load bearing surfaces along the outer side of the tubular member, the load bearing surfaces being constructed and arranged in order to allow a substantial axial load to be imparted onto said tubular member, such that a pipeline to which said tubular member is connected can be suspended from a pipeline laying vessel, wherein a plurality of load bearing surfaces are provided for engaging a movable support device on the pipelay vessel and a plurality of load bearing surfaces are provided for engaging a fixed support device on the pipelay vessel.

44. A pipe assembly of a tubular member according to claim 35 and one or more regular pipe sections, the tubular member and the one or more regular pipe sections being joined to one another in an end-to end relationship.

45. A support device configured to be used on board a pipelay vessel, the fixed or movable support structure comprising:
at least one tapered support surface constructed to engage a first tubular member, the first tubular member configured to be supported by a pipe support device of a pipelay system on board a pipelay vessel, the first tubular member comprising at least one load bearing surface which is formed along the outer side of the first tubular member, the load bearing surface being configured such that a weight of a pipeline suspended from the vessel can be carried via the at least one load bearing surface, wherein the at least one load bearing surface tapers outwardly with respect to a main longitudinal axis of said first tubular member, and/or
a plurality of support surfaces constructed to engage a second tubular member, the second tubular member configured to form part of a pipeline which is laid by a pipeline laying vessel, the second tubular member comprising a plurality of load bearing surfaces which are formed along the outer side of the second tubular member, the load bearing surfaces being constructed and arranged in order to allow a substantial axial load to be imparted onto said second tubular member, such that a pipeline to which said tubular member is connected can be suspended from a pipeline laying vessel, wherein a plurality of load bearing surfaces are provided for engaging a movable support device on the pipelay vessel and a plurality of load bearing surfaces are provided for engaging a fixed support device on the pipelay vessel;
wherein the support device comprises outer dimensions which correspond to a known collar of a known pipe section used in a known J-lay method, the support device being configured to mimic said known collar.

46. The support device according to claim 45, the support device being installable and removable from a pipe section.

47. A pipeline manufactured by the method of claim 23

48. A pipeline comprising tubular members according to claim 1.

49. A pipeline manufactured by the method of claim 41

50. A pipeline comprising tubular members according to claim 35.
